(19) United States
(12) Patent Application Publication
(10) Pub. No.: US 2024/0109131 A1
(43) Pub. Date: Apr. 4, 2024

(54) CUTTING TOOL WITH NOZZLE HAVING MULTIPLE INTEGRATED FLUID OUTLETS

(71) Applicant: KENNAMETAL INDIA LIMITED, Bangalore (IN)

(72) Inventors: Iranna Shidrameshetra, Bangalore (IN); Yogesh Basavaraju, Bangalore (IN); Poomachander Shanthamraju, Bangalore (IN); Rakesh Muniyappa, Bangalore (IN); Igor Kaufmann, Fuerth (DE)

(21) Appl. No.: 18/375,789

(22) Filed: Oct. 2, 2023

(30) Foreign Application Priority Data
Oct. 3, 2022 (IN) 202241056659

(51) Int. Cl. B23B 27/10

(52) U.S. Cl. CPC B23B 27/10

(57) ABSTRACT

A cutting tool includes a main body having a working end and an attachment end. A seat is disposed in the working end to receive a cutting insert. A main body passageway for the communication of fluid is disposed in the main body and has a passageway end disposed in the working end. A cutting insert is disposed in the seat. A nozzle is disposed in the passageway end. The nozzle has a nozzle body including front and rear surfaces. The front surface faces generally toward the seat, and the rear surface faces generally away from the seat. The nozzle body defines a plurality of nozzle passageways that extend therethrough between the front and rear surfaces. Each nozzle passageway has a fluid outlet at the front surface.

### RELATED APPLICATION DATA

The present application claims priority under 35 U.S.C. § 119 to Indian Patent Application No. 202241056659 filed on Oct. 3, 2022, the disclosure of which is incorporated by reference herein in its entirety.

### FIELD

This relates in general to cutting tools for metal working.

### BACKGROUND

During a metalworking operation with a rotary or stationary cutting tool, it is common to use a fluid, such as a coolant or a lubricant, to control debris from the workpiece and/or the temperature of the workpiece and/or the cutting tool.

One known method to apply fluid to the workpiece and/or tool includes use of a separate liquid dispensing system. Such systems are manufactured, assembled, and arranged separately from the cutting tool, and are often capable of jetting streams or droplets of liquid at the workpiece and/or the cutting tool.

Another known method to apply fluid to the workpiece and/or tool includes use of one or more nozzles in fluid communication with one or more passageways in the cutting tool or cutting tool holder to direct fluid at the workpiece or the cutting tool.

### SUMMARY

This relates more particularly to a cutting tool with a nozzle having multiple integrated fluid outlets.

The cutting tool includes a main body having a working end and an attachment end. A seat disposed in the working end to receive a cutting insert. A main body passageway for the communication of fluid is disposed in the main body and has a passageway end disposed in the working end. A cutting insert is disposed in the seat.

A nozzle is disposed in the passageway end. The nozzle has a nozzle body including front and rear surfaces. The front surface generally faces toward the seat, and the rear surface generally faces away from the seat. The nozzle body defines a plurality of nozzle passageways extending therethrough between the front and rear surfaces. Each nozzle passageway has a fluid outlet at the front surface.

In at least one embodiment the plurality of nozzle passageways includes at least two or more nozzle passageways. For example, in at least one embodiment, the plurality of nozzle passageways includes three nozzle passageways, and in at least one other embodiment the plurality of nozzle passageways includes five nozzle passageways. It must understood, however, that the plurality of nozzle passageways may include any number of nozzle passageways two or more.

The nozzle defines a central axis between the front and rear surfaces, and, in some embodiments, a number of the plurality of nozzle passageways extend through the nozzle body parallel to the central axis. In other embodiments, number of the plurality of nozzle passageways extend through the nozzle body askew to the central axis. In further embodiments, the nozzle includes one or more passageways extending through the nozzle body parallel to the central axis and one or more passageways extending through the nozzle body askew to the central axis. Where at least two of the plurality of nozzle passageways extend through the nozzle body askew to the central axis, these passageways may extend at different angles to the central axis relative to each other. The nozzle central axis may align with or be askew to its respective passageway in the main body.

The plurality of nozzle passageways may have fluid outlets with different cross-sectional shape. For example, the nozzle passageways may have a fluid outlet with a circular cross-sectional shape, or a triangular cross-sectional shape, or any other geometric shape. In at least one embodiment, the nozzle passageways have fluid outlets with differing cross-sectional shapes. Further, the plurality of nozzle passageways have fluid outlets with different cross-sectional size. The fluid outlets may be formed in a separate nozzle cover mounted to the nozzle body. In any case, the nozzle or an assembly comprising the nozzle may be made is any suitable conventional or non-conventional process, such as forming of a unitary body and machine finished, forming of separate components that are then joined together and optionally machine finished if desired, and/or additively manufactured with or without machine finishing,

In at least one embodiment, the main body passageway end has threads disposed there on, and the nozzle body has threads disposed on a circumferential outer surface extending between the front and rear surface, and the nozzle is retained in the passageway end by engagement of the main body threads and the nozzle threads. In other embodiments, the nozzle is retained in the main body passageway end by press-fit. In further embodiments the main body and nozzle body are assembled with a metal joining/bonding process like brazing, welding, or fusing. In additional embodiments the main body and nozzle body are joined with other mechanical fastening arrangements.

In some embodiments, the nozzle rear surface has a frustoconical shape having a partial conical surface and a circular surface. In at least one embodiment at least one nozzle passageway extends through the circular surface. In at least one embodiment at least one nozzle passageway extends through the circular surface and the partial conical surface.

In some embodiments, the front surface is a planar surface. In other embodiments the front surface is non-planar. For example, the front surface may be a concave or a convex surface as desired.

In some embodiments, the nozzle passageway outlets are integrally formed in the nozzle body. In some embodiments, nozzle passageway outlets are separately formed from the nozzle body and fixed to the nozzle body at nozzle passageways, respectively.

The nozzle may be fully disposed within the main body passageway.

The nozzle may be the only nozzle associated with the main body.

Various aspects will become apparent to those skilled in the art from the following detailed description and the accompanying drawings.

### BRIEF DESCRIPTION OF THE DRAWINGS

FIG. 1 is a side view of a cutting tool with a nozzle having multiple integrated fluid outlets.

FIG. 2 is a top view of the cutting tool of FIG. 1.

FIG. 3 is an upper front right perspective view of the cutting tool of FIG. 1.

FIG. 4 is a partial front view of the cutting tool of FIG. 1.

FIG. 5 is an enlarged front right perspective view of a portion of the cutting tool of FIG. 1.

FIG. 6 is a rear perspective view of the nozzle of the cutting tool of FIG. 1.

FIG. 7 is an upper front perspective schematic view of the nozzle of FIG. 6.

FIG. 8 is a view of an alternative cutting tool similar to FIG. 5 except showing a nozzle having five fluid outlets.

FIG. 9 is a view of the nozzle of FIG. 8 similar to FIG. 6.

FIG. 10 is a schematic representation of the front face of a nozzle for a cutting tool having multiple integrated fluid outlets of differing shapes.

### DETAILED DESCRIPTION

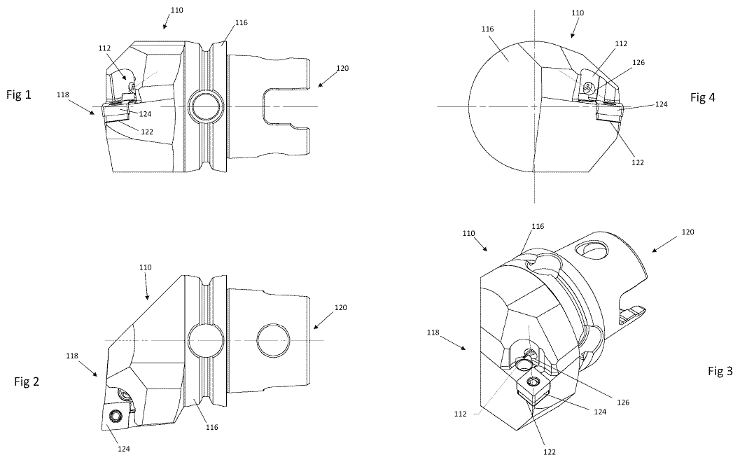

Referring now to the drawings, there is illustrated in FIGS. 1-5 a cutting tool 110 with a nozzle 112 having multiple integrated fluid outlets 114.

The cutting tool 110 includes a main body 116 having a working end 118 and an attachment end 120. A seat 122 disposed in the working end 118 to receive a cutting insert 124. The cutting insert 124 is disposed in the seat 122. A main body passageway for the communication of fluid is disposed in the main body 116 and has a passageway end 126 disposed in the working end 118.

As best shown in FIGS. 5-7, the nozzle 112 is disposed in the passageway end 126. The nozzle 112 has a nozzle body 128 including front surface 130 and rear surface 132. The front surface 130 generally faces toward the seat 122, and the rear surface 132 generally faces away from the seat 122. The nozzle body 128 defines a plurality of nozzle passageways 134 extending therethrough between the front and rear surfaces 130 and 132. Each nozzle passageway 134 has a fluid outlet 114 at the front surface 130. In the illustrated embodiment, the nozzle 112 includes three nozzle passageways 134. However, it must be understood that a nozzle may include any suitable plurality of passageways as desired for fluid flow and direction. Further, it must be understood that each fluid outlet 114 may be in an orientation as desired, aligned with or askew to any other fluid outlet 114. The fluid outlets 114 may be formed in a separate nozzle cover mounted to the nozzle 112.

The nozzle 112 defines a central axis A between the front and rear surfaces 130 and 132. In the illustrated embodiment the nozzle passageways 134 all angle toward the central axis A from the rear surface 132 to the front surface 130. In some embodiments, a number of the plurality of nozzle passageways 134 extend through the nozzle body 128 parallel to the central axis A. In other embodiments, a number of the plurality of nozzle passageways 134 extend through the nozzle body 128 askew to the central axis A. In further embodiments, the nozzle 112 includes one or more passageways 134 extending through the nozzle body 128 parallel to the central axis A and one or more passageways 134 extending through the nozzle body 128 askew to the central axis A. In any case, where at least two of the plurality of nozzle passageways 134 extend through the nozzle body 128 askew to the central axis A, these passageways 134 may extend at different angles to the central axis A relative to each other. The central axis A of the nozzle body 128 may align with or be askew to its respective passageway end 126 in the main body 116.

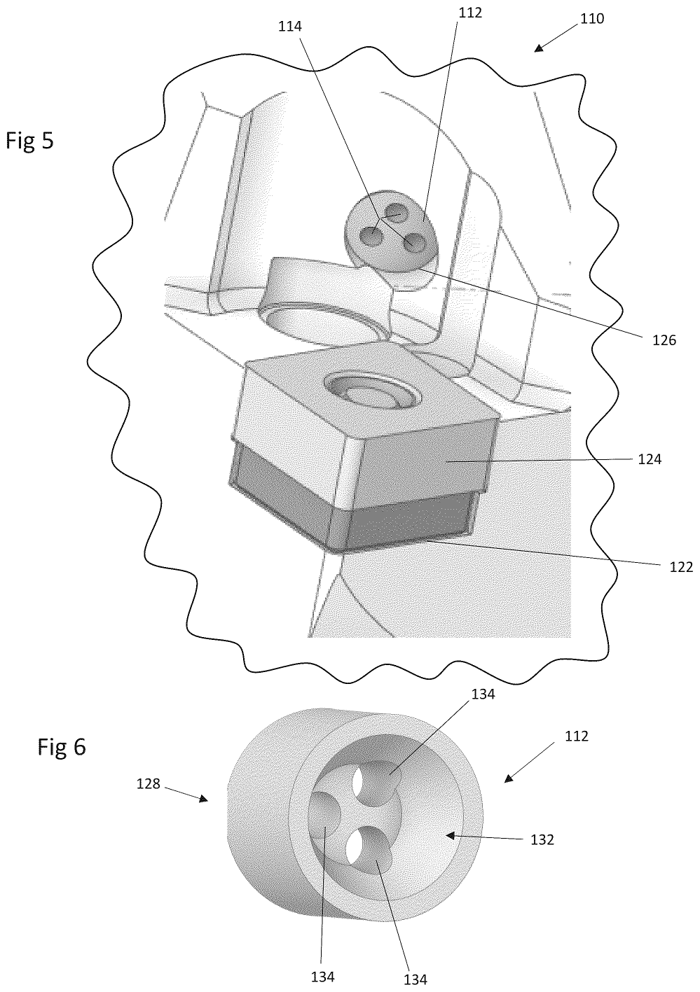

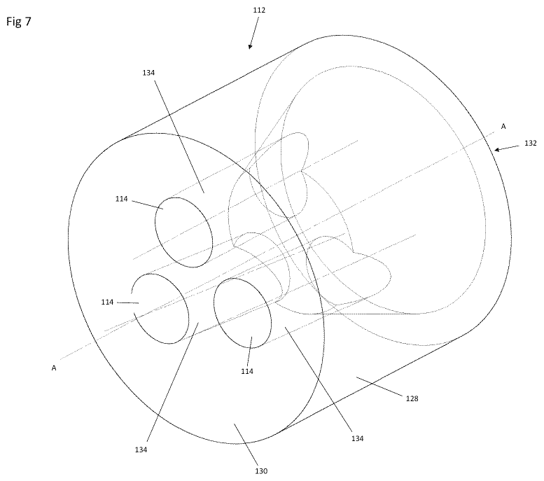

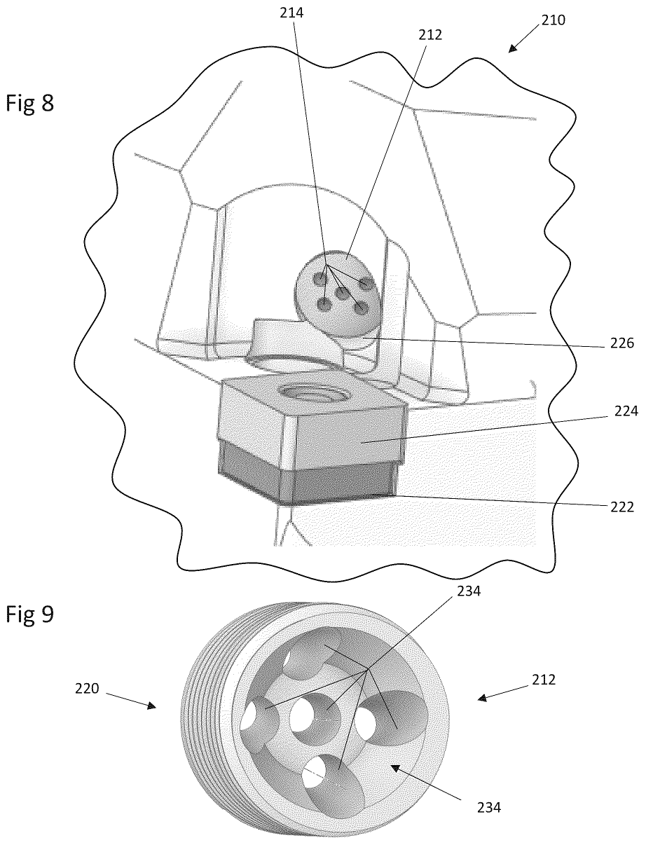

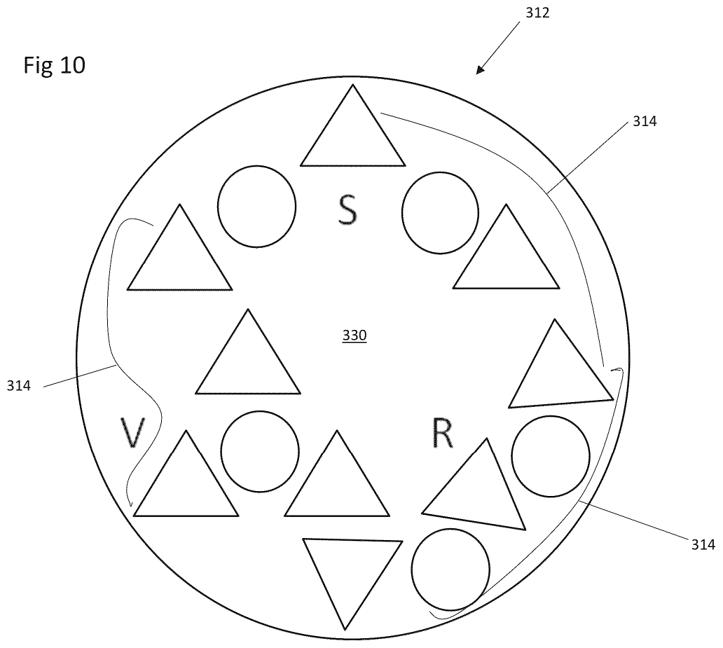

There is shown, in FIGS. 8 and 9, an alternative cutting tool 210 similar to the cutting tool 110 shown in FIGS. 5 and 6 except having a nozzle 212 having five fluid outlets 214. Elements in FIGS. 8 and 9 that are similar to elements in FIGS. 5 and 6 are numbered with similar reference numbers.

In the embodiment shown in FIGS. 8 and 9, the main body passageway end 226 has threads disposed there on, and the nozzle body 228 has threads disposed on a circumferential outer surface extending between the front and rear surfaces 230 and 232, and the nozzle 212 is retained in the passageway end 226 by engagement of the main body threads and the nozzle threads. In other embodiments, the nozzle is retained in the main body passageway end by press-fit, brazing, welding, or any other suitable fixation mechanism.

As shown schematically in FIG. 10, a front face 330 of a nozzle 312 for a cutting tool may include a plurality of nozzle passageways 334 having fluid outlets 314 with different cross-sectional shape. For example, the nozzle passageways 334 may have a fluid outlet 314 with a circular cross-sectional shape, or a triangular cross-sectional shape, or any other geometric shape. In other embodiments, the nozzle passageways 334 may terminate with inserts of the desired outlet size and geometry or may include facia having outlets of the desired size and geometry. In at least one embodiment, the nozzle passageways 334 have fluid outlets with differing cross-sectional shapes. Further, the plurality of nozzle passageways 334 have fluid outlets with different cross-sectional size.

In some embodiments, the nozzle rear surface 132, 232 has a frustoconical shape having a partial conical surface and a circular surface. In at least one embodiment at least one nozzle passageway 134, 234 extends through the circular surface. In at least one embodiment at least one nozzle passageway 134, 234 extends through the circular surface and the partial conical surface. In some embodiments, the front surface nozzle is a planar surface. In other embodiments the front surface is non-planar. For example, the front surface may be a concave or a convex surface as desired. In some embodiments the rear surface 132.232 may be planar, parabolic, semi-circular, partial geometrical shape such as diamond or pyramidal, or any other shape as desired.

In some embodiments, the nozzle passageway outlets are integrally formed in the nozzle body. In some embodiments, nozzle passageway outlets are separately formed from the nozzle body and fixed to the nozzle body at nozzle passageways, respectively. In any case, the nozzle or an assembly comprising the nozzle may be made is any suitable conventional or non-conventional process, such as forming of a unitary body and machine finished, forming of separate components that are then joined together and optionally machine finished if desired, and/or additively manufactured with or without machine finishing,

As shown in the illustrated embodiments, the nozzle 112, 212 may be fully disposed within the main body passageway 126, 226. Alternatively, a nozzle may extend beyond the end of the main body passageway.

It is contemplated that the nozzle 112, 212 may be the only nozzle associated with the main body 116, 216. That is to say that the cutting tool 110, 210 only has one nozzle in total, the singular nozzle having multiple integrated fluid outlets.

It is believed that use of cutting tool with a single nozzle having multiple integrated outlets will achieve higher mass flow and velocity as compared to a cutting tool with multiple nozzles each having single outlets. Further, this is believed to also enhance tool life, and help to break relatively smaller chips, for example, in soft steel machining.

Testing has shown that, without affecting the stiffness of a cutting tool or tool holder system, the use of a singular nozzle with multiple integrated outlets improves coolant delivery (mass flow) by 40 to 50%, which increases tool life (more heat absorption during machining) and velocity improved by 20% to 25% which increases formation of good chips or avoid continuous chips, as compared to conventional delivery systems with one or more nozzles with singular outlets.

Further, it has been discovered that different positions of multiple outlets of a single nozzle increases wetting area or coverage of the cutting edge, as compared to conventional delivery systems.

While principles and modes of operation have been explained and illustrated with regard to particular embodiments, it must be understood, however, that this may be practiced otherwise than as specifically explained and illustrated without departing from its spirit or scope.

What is claimed is:

1. A cutting tool comprising:
a main body including a working end and an attachment end with a seat disposed in the working end to receive a cutting insert, and a main body passageway for the communication of fluid disposed in the main body and having an passageway end disposed in the working end;
a cutting insert disposed in the seat; and
a nozzle disposed in the passageway end, the nozzle having a nozzle body including front and rear surfaces, the front surface facing generally toward the seat, and the rear surface facing generally away from the seat, the nozzle body defining a plurality of nozzle passageways extending therethrough between the front and rear surfaces, each nozzle passageway having a fluid outlet at the front surface.

2. The cutting tool of claim 1 where the plurality of nozzle passageways includes at least three nozzle passageways.

3. The cutting tool of claim 2 where the plurality of nozzle passageways includes at least five nozzle passageways.

4. The cutting tool of claim 1 where the nozzle defines a central axis between the front and rear surfaces, and where the plurality of nozzle passageways extend through the nozzle body parallel to the central axis.

5. The cutting tool of claim 1 where the nozzle defines a central axis between the front and rear surfaces, and where at least one of the plurality of nozzle passageways extends through the nozzle body askew to the central axis.

6. The cutting tool of claim 1 where at least two of the plurality of nozzle passageways extend through the nozzle body askew to the central axis, and at different angles to the central axis relative to each other.

7. The cutting tool of claim 1 where at least two of the plurality of nozzle passageways have fluid outlets with different cross-sectional shape.

8. The cutting tool of claim 7 where at least one of the nozzle passageways has a fluid outlet with a circular cross-sectional shape.

9. The cutting tool of claim 7 where at least one of the nozzle passageways has a fluid outlet with a triangular cross-sectional shape.

10. The cutting tool of claim 1 where at least two of the plurality of nozzle passageways have fluid outlets with different cross-sectional size.

11. The cutting tool of claim 1 where main body passageway end has threads disposed there on, and the nozzle body has threads disposed on a circumferential outer surface extending between the front and rear surface, and where the nozzle is retained in the passageway end by engagement of the main body threads and the nozzle threads.

12. The cutting tool of claim 1 where the nozzle is retained in the main body passageway end by press-fit.

13. The cutting tool of claim 1 where the nozzle is retained in the main body passageway end by one of brazing, welding, or fusing.

14. The cutting tool of claim 1 the nozzle rear surface has a frustoconical shape having a partial conical surface and a circular surface.

15. The cutting tool of claim 14 where at least one nozzle passageway extends through the circular surface.

16. The cutting tool of claim 14 where at least one nozzle passageway extends through the circular surface and the partial conical surface.

17. Then cutting tool of claim 1 where the front surface is a planar surface.

18. Then cutting tool of claim 1 where the front surface is a non-planar surface.

19. The cutting tool of claim 1 where the nozzle passageway outlets are integrally formed in the nozzle body.

20. The cutting tool of claim 1 where the nozzle passageway outlets are separately formed from the nozzle body and fix to the nozzle body at nozzle passageways, respectively.

21. The cutting tool of claim 1 where the nozzle is fully disposed within the main body passageway.

22. The cutting tool of claim 21 where the nozzle is the only nozzle associated with the main body.

23. The cutting tool of claim 1 where the nozzle is the only nozzle associated with the main body.
